(19) United States
(12) Patent Application Publication
(10) Pub. No.: US 2015/0253520 A1
(43) Pub. Date: Sep. 10, 2015

(54) TRANSMITTING DEVICE PACKAGE STRUCTURE

(71) Applicant: LuxNet Corporation, Zhongli City (TW)

(72) Inventors: Yun-Cheng Huang, Zhongli City (TW); Chung-Hsin Fu, Zhongli City (TW); Hua-Hsin Su, Zhongli City (TW); Huang-Shen Lin, Zhongli City (TW); Nai-Hsin Chen, Zhongli City (TW)

(21) Appl. No.: 14/304,514

(22) Filed: Jun. 13, 2014

(30) Foreign Application Priority Data
Mar. 10, 2014 (TW) 103204034

(51) Int. Cl. G02B 6/42

(52) U.S. Cl. CPC G02B 6/423; G02B 6/4206

(57) ABSTRACT

A transmitting device package structure comprises a base mounted with a transmitting module, a circuit board, and a cylindrical element. The base comprising a plane part mounted with a transmitting module, and an assembling part disposed on one side of the plane part. The circuit board comprises a board body, an electrical connection side disposed on one end of the board body and connected with the transmitting module, and an electrical connection port disposed an end of the board body opposite to the electrical connection side. The cylindrical element is mounted on the assembling part. The cylindrical element comprises a cylindrical body connected to the external optical fiber, and a coupling lens disposed inside the cylindrical body or one side of the cylindrical body, and the coupling lens couples the optical signal emitted from the transmitting module to the external optical fiber.

### BACKGROUND OF THE INVENTION

1. Field of the Invention

The present disclosure is related to a transmitting device package structure, more particularly, to a transmitting device package structure which is adapted for QSFP and can be detached individually for replacement.

2. Description of the Related Art

As science and technology are updated rapidly, processing speed and capacity of the computer increase correspondingly. The communication transmission using the traditional cable is limited to bandwidth and transmission speed of the traditional cable and mass information transmission required in modern life causes the traditional communication transmission overload. To correspond to such requirement, the optical fiber transmission system replaces the traditional communication transmission system gradually. The optical fiber transmission system does not have bandwidth limitation, and also has advantages of high speed transmission, long transmission distance, its material not interfered by the electromagnetic wave. Therefore, present electronic industrial performs research toward optical fiber transmission which will become the mainstream in the future. Said optical communication is a technology in that light wave functions as signal carrier and transmitted between two nodes via the optical fiber. Field of the optical communication can be divided into optical communication side and electric communication side according to transmission medium. By the optical transceiver, the received optical signal can be converted to an electrical signal capable of being processed by an IC, or the processed electrical signal can be converted to the optical signal to be transmitted via optical fiber. Therefore, objective of communication can be achieved.

Wavelength-division multiplexing (WDM) is a multitask technology of processing multiple optical carrier signals transmitted by the optical fiber, and this technology is applied on the different wavelength signal or transmission of laser optical signal. This technology is implemented in bidirectional transmission of signal on the optical fiber to double transmission capacity. Besides, the term “wavelength-division multiplexing” is mostly applied in optical carrier, and frequency-division multiplexing is applied in radio carrier. Moreover, both of wavelength and frequency are in reciprocal relationship, so their concept can be applied to each other.

Actually, wavelength-division multiplexing is implemented by dividing the work wavelength of optical fiber into multiple channels to enable mass data transmission in one optical fiber. A whole wavelength-division multiplexing system can be divided into a wavelength division multiplexer at transmitting end and a wavelength division demultiplexer at receiving end. At present, there are commercial wavelength division multiplexer/demultiplexer which can divide 80 channels in the optical fiber communication system, so that the data transmission speed can exceed grade of Tb/s effectively.

In the transmitting module adapted for WDM technology, the connector usually has single light transmitter structure. However, such light transmitter structure can emit optical signals with different frequencies, but cannot be repaired for individual frequency. Therefore, whole light transmitter must be replaced if being damaged, and it causes larger consumption in cost.

### SUMMARY OF THE INVENTION

To achieve above objective, the present disclosure provides a transmitting device package structure. The transmitting device package structure comprises a base mounted with a transmitting module, a circuit board disposed at one side of the base, and a cylindrical element mounted at one side of the base for coupling light signal to an external optical fiber. The base comprises a plane part mounted with a transmitting module, and an assembling part disposed on one side of the plane part. The circuit board comprises a board body, an electrical connection side disposed on one end of the board body and connected with the transmitting module, and an electrical connection port disposed an end of the board body opposite to the electrical connection side. The cylindrical element is mounted on the assembling part. The cylindrical element comprises a cylindrical body connected to the external optical fiber, and a coupling lens disposed inside the cylindrical body or between the cylindrical body and the transmitting module. The coupling lens couples the optical signal emitted from the transmitting module to the external optical fiber.

Preferably, the coupling lens is disposed between the cylindrical body and the transmitting module, and the cylindrical body comprises a plane adjusting mechanism integrated with the assembling part, a light distance adjusting mechanism integrated with the plane adjusting mechanism, and an optical fiber connection mechanism integrated with the light distance adjusting mechanism.

Preferably, the assembling part comprises an annular positioning portion disposed at one side of the plane part, a positioning groove disposed inside the annular positioning portion to dispose the coupling lens, a first connection plane disposed at one side of the annular positioning portion, and the plane adjusting mechanism comprises a mechanism body, and a second connection plane disposed at one side of the mechanism body and fixed to the first connection plane after a coupling calibration.

Preferably, the plane adjusting mechanism comprises a mechanism body, a groove track disposed at one side of the mechanism body, and the light distance adjusting mechanism comprises a body, an inserted part disposed at one side of the body and slidable along the groove track and fixed to an inserted part on the groove track after a coupling calibration.

Preferably, the coupling lens comprises a metal outer ring part fixed on the positioning groove, and at least one convex lens or spherical lens disposed inside the metal outer ring part.

Preferably, the cylindrical body comprises an isolator between the optical fiber connection mechanism and the light distance adjusting mechanism.

Preferably, the light distance adjusting mechanism comprises a body, a first disposal slot disposed at one side of the body to mount the isolator, and a second disposal slot disposed on the body and at one side of the first disposal slot, and the optical fiber connection mechanism comprises a sleeve body, a light coupling channel disposed inside the sleeve body to connect with an external optical fiber, and a positioning portion disposed on the sleeve body and at a side of the light coupling channel opposite to the external optical fiber for fixing the second disposal slot.

Preferably, the cylindrical body comprises a plane adjusting mechanism integrated with the assembling part and an optical fiber connection mechanism integrated with the plane adjusting mechanism, and the coupling lens is disposed inside the optical fiber connection mechanism.

Preferably, the assembling part comprises an annular positioning portion disposed at one side of the plane part, an assembly slot disposed inside the annular positioning portion, and a first connection plane disposed at one side of the annular positioning portion, and the plane adjusting mechanism comprises a mechanism body, a through slot disposed inside the mechanism body and corresponding to the assembly slot, and a second connection plane disposed at one side of the mechanism body and fixed to the first connection plane after a coupling calibration.

Preferably, the optical fiber connection mechanism comprise a sleeve body, a light distance adjusting part disposed at one side of the sleeve body and passing through the through slot and the assembly slot, and a coupling lens disposed inside the light distance adjusting part.

Preferably, the optical fiber connection mechanism comprises a light coupling channel disposed inside the sleeve body and coupling an optical signal which passes the coupling lens, to the external optical fiber.

Preferably, the optical fiber connection mechanism comprises a positioning groove disposed inside the light distance adjusting part, and the coupling lens comprises a metal outer ring part fixed on the positioning groove and at least one convex lens or spherical lens disposed inside the metal outer ring part.

Therefore, the present disclosure has the following advantages.

First, the transmitting device of the present disclosure can be detached independently, so that assembly engineer can replace single transmitting device in failure.

Secondly, the baseboard and cylindrical element of transmitting device of the present disclosure can be detached and detected individually, so that the cylindrical element provided with the coupling lens can be recycled for reuse when the transmitting module is damaged.

### BRIEF DESCRIPTION OF THE DRAWINGS

The detailed structure, operating principle and effects of the present disclosure will now be described in more details hereinafter with reference to the accompanying drawings that show various embodiments of the invention as follows.

FIG. 1 is a first schematic view of an optical transceiver module according to the present disclosure.

FIG. 2 is a second schematic view of an optical transceiver module according to the present disclosure.

FIG. 3 is a schematic view of a first embodiment according to the present disclosure.

FIG. 4 is a first exploded view of the first embodiment according to the present disclosure.

FIG. 5 is a second exploded view of the first embodiment according to the present disclosure.

FIG. 6 is a top view of the first embodiment according to the present disclosure.

FIG. 7 is a section view of the FIG. 5 along the line A-A.

FIG. 8 is a section view of the FIG. 5 along the line B-B.

FIG. 9 is a schematic view of a second embodiment according to the present disclosure.

FIG. 10 is a first exploded view of the second embodiment according to the present disclosure.

FIG. 11 is a second exploded view of the second embodiment according to the present disclosure.

FIG. 12 is a top view of the second embodiment according to the present disclosure.

FIG. 13 is a section view of the FIG. 11 along the line A-A.

FIG. 14 is a section view of the FIG. 11 along the line B-B.

### DETAILED DESCRIPTION OF THE PREFERRED EMBODIMENTS

The technical content of the present disclosure will become apparent by the detailed description of the following embodiments and the illustration of related drawings as follows.

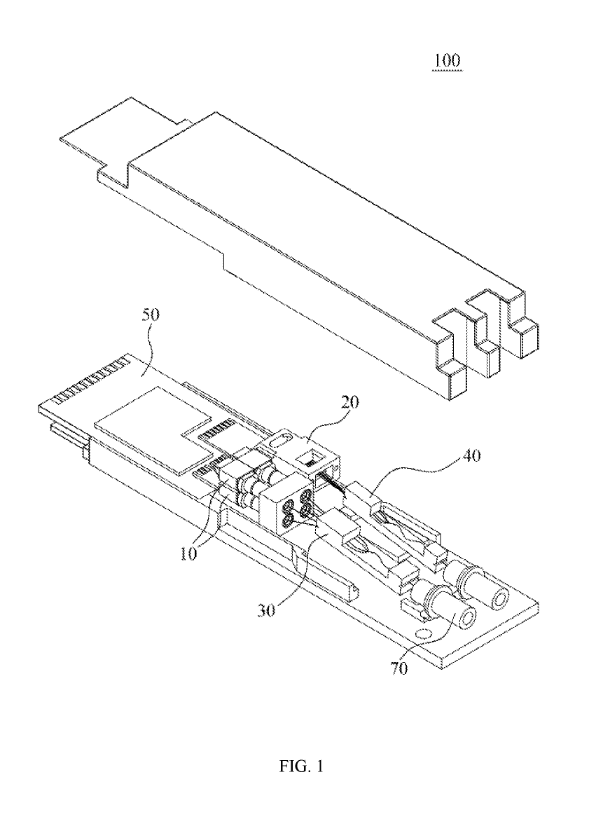

Please refer to FIG. 1 to FIG. 3 which are schematic views of an optical transceiver module installed with a transmitting device according to the present disclosure, and the transmitting device according to the present disclosure respectively. The connector 70 shown in FIG. 1 is configured with standard of Lucent Connector/Local Connector (LC). The optical transceiver module 100 in this embodiment applies technology of wavelength-division multiplexing (WDM), a plurality of transmitting device 10 introduce light of different wavelengths to one single-mode optical fiber via wavelength-division multiplexer 30 respectively, for middle distance and long distance transmission in single mode optical fiber. Next, in the optical receiver 20 at the other side, the received optical signal is performed a light-split process by the demultiplexer 40 and the split optical signals are introduced to different channels. In this embodiment, except WDM technology, the optical transceiver module 100 also can be applied to related optical communication technologies, such as binary phase shift keying modulation (BPSK), quadrature phase shift keying modulation (QPSK), conventional/coarse wavelength division multiplexing (CWDM), dense wavelength division multiplexing (DWDM), and optical add/drop multiplexer (OADM), reconfigurable optical add/drop multiplexer (ROADM).

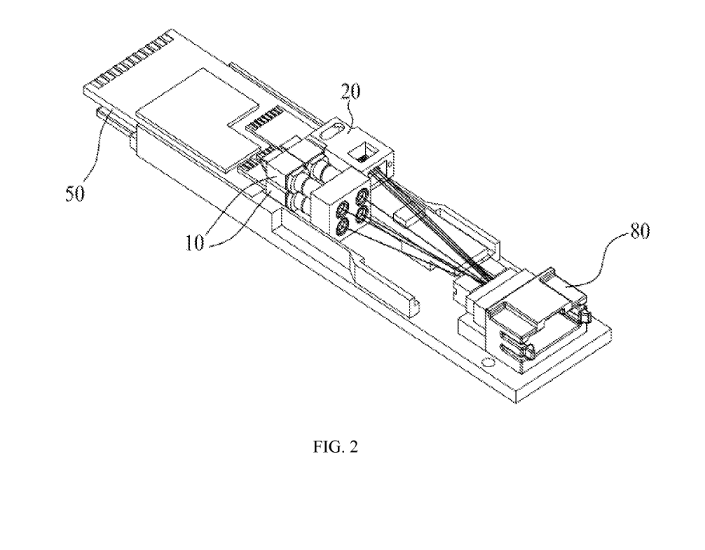

The connector 80 shown in FIG. 2 is configured with the standard of multi-fiber push on (MPO). The optical fibers in this embodiment are connected one by one in multi-channel way without steps of splitting light and demultiplexing split light, so that the material and space of the splitting multiplexer and the demultiplexer can be saved.

In the present disclosure, the transmitting component is an edge-emission laser diode or an assembly of the edge-emission laser diode and a baseboard or other electronic component, but it is not limited thereto.

### First Embodiment

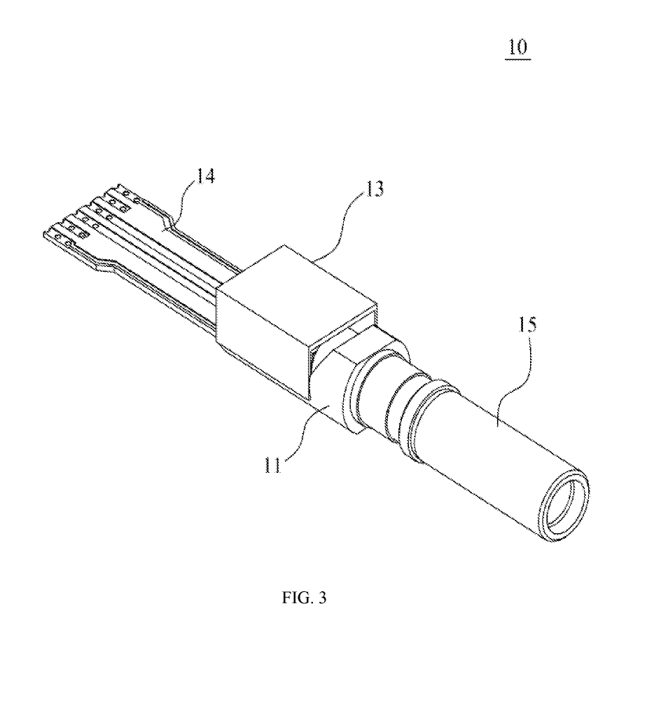

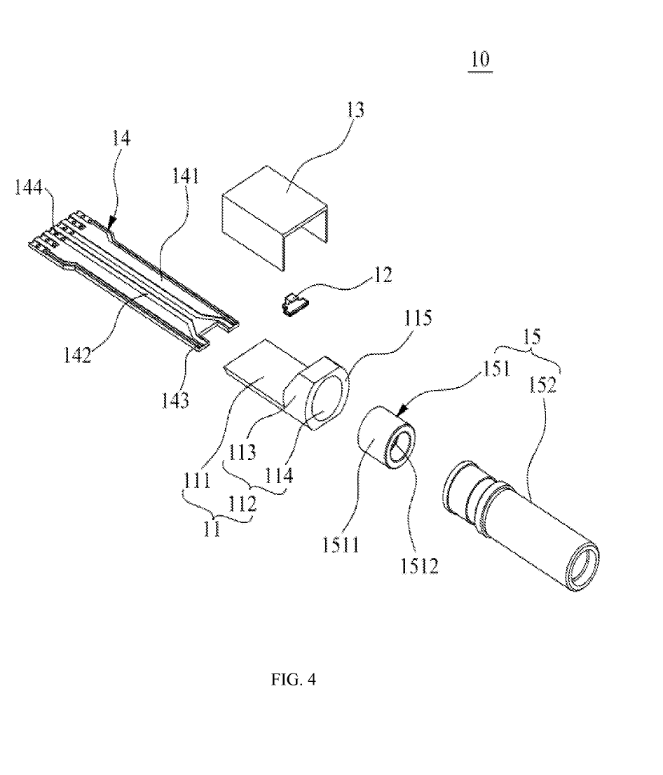

Please refer to FIG. 3 to FIG. 8 for detail structure of a first the embodiment according to the present disclosure. Please refer to FIG. 3 and FIG. 4 first, in this embodiment, a package structure for transmitting device 10 is provided. The package structure for transmitting device 10 mainly comprises a base 11, a transmitting module 12 disposed on the base 11, a cover 13 covering above the transmitting module 12, a circuit board 14 disposed at one side of the base 11 and a cylindrical element 15 mounted at one side of the base 11. The base 11 is made of metal material and can assist the transmitting module 12 to dissipate heat. The base 11 comprises a plane part 111, and an assembling part 112 disposed on one side the plane part 111. The plane part 111 is used to place the transmitting module 12. The assembling part 112 comprises an annular positioning portion 113 disposed at one side of the plane part 111. A positioning groove 114 is disposed inside the annular positioning portion 113 and corresponds to the transmitting module 12. The positioning groove 114 is disposed correspondingly to a coupling lens 151 of the cylindrical element 15. The structure of the cylindrical element 15 will be described in detail in following content. The coupling lens 151 comprises a metal outer ring part 1511 fixed on the positioning groove 114, and at least one convex lens or spherical lens, such as biconvex lens 1512, disposed inside the metal outer ring part 1511. The plane part 111 of the base 11 is covered by the cover 13. During manufacturing process, filler is sealed into space between the cover 13 and the base 11 by infusion or welding, in order to achieve the objective of sealing the transmitting module 12.

One end of the circuit board 14 is integrated with the base 11. The circuit board 14 comprises a board body 141 having a printing circuit 142, an electrical connection side 143 disposed on one end of the board body 141, and an electrical connection port 144 disposed on an end of the board body 141 opposite to the electrical connection side 143. The electrical connection side 143 of the board body 141 is fixed on the plane part 111 of the base 11 by gluing. The transmitting module 12 is connected electrically to the electrical connection side 143 of the board body 141 by welding or wire bonding. The electrical connection port 144 is connected to the baseboard 50 of the optical transceiver module 100, as shown in FIG. 1, and connected electrically to the printing circuit on the baseboard 50 by electrical welding, spot welding or slot connection, so as to transmit the excitation signal from the signal process module on the baseboard 50 to the transmitting module 12. The cylindrical element 15 is mounted on the assembling part 112 correspondingly. The cylindrical element 15 comprises a cylindrical body 152 connected to the external optical fiber which is not shown in figure. In this embodiment, the coupling lens 151 is disposed at one side of the cylindrical body 152, so as to couple the optical signal emitted from the transmitting module 12 to the external optical fiber via the cylindrical body 152.

Please refer to FIG. 5 to FIG. 8 for detail structure of the cylindrical element 15 in the first embodiment according to the present disclosure. The structure of the cylindrical element 15 is described in order from left to right.

In the exploded view of structure in FIG. 5, the cylindrical element 15 is divided mainly into the coupling lens 151 and the cylindrical body 152. The cylindrical body 152 can be disassembled into a plane adjusting mechanism 1521, a light distance adjusting mechanism 1522, an isolator 1523, and an optical fiber connection mechanism 1524, in order from left to right.

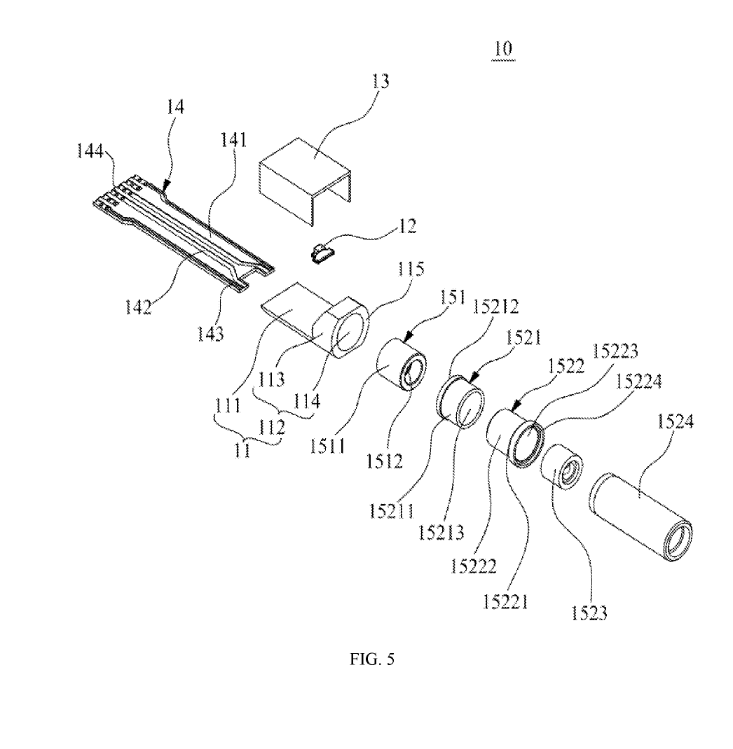

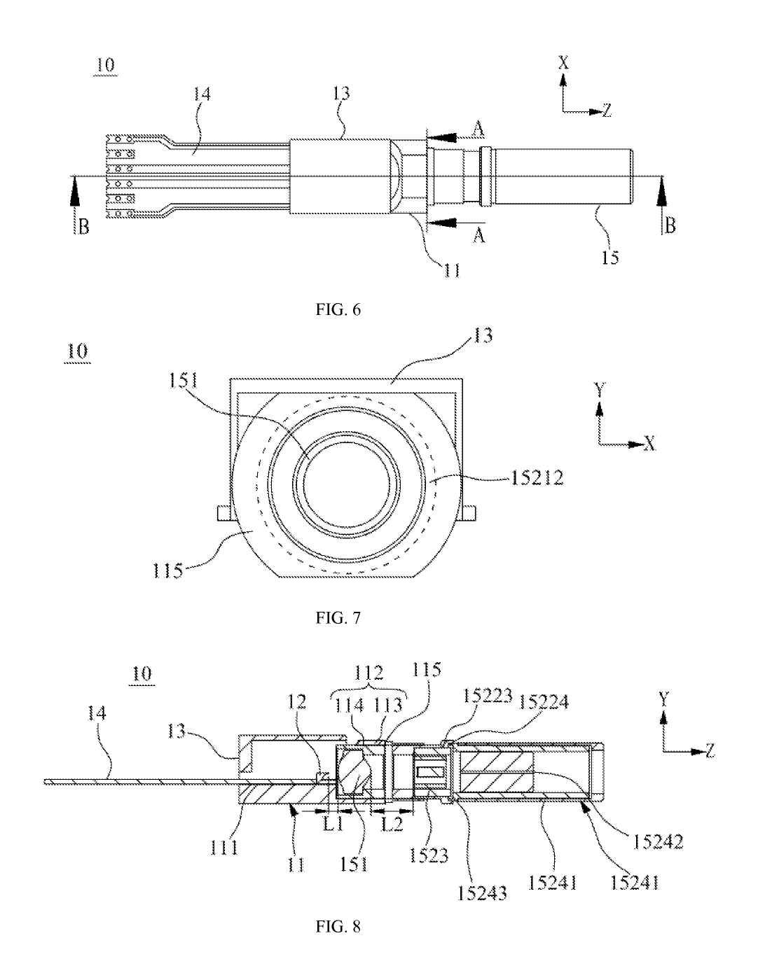

Please refer to both of FIG. 6 and FIG. 7, the plane adjusting mechanism 1521 is integrated on the assembling part 112 by welding after coupling calibration is completed, and space between the plane adjusting mechanism 1521 and the assembling part 112 is sealed by infusing filler. For X-Y plane calibration, the assembling part 112 of the base 11 comprises a first connection plane 115 disposed at one side of the annular positioning portion 113. The plane adjusting mechanism 1521 comprises a mechanism body 15211 and second connection plane 15212 disposed at one side of the mechanism body 15211. The second connection plane 15212 corresponds to the first connection plane 115. During calibration, a calibration device is used to adjust the relative position between the cylindrical body 152 and the assembling part 112. After the calibration is done, the first connection plane 115 is fixed on the second connection plane 15212 by laser spot welding, and then X-Y plane calibration is completed.

Please refer to both of FIG. 6 and FIG. 8, the light distance adjusting mechanism 1522 is integrated on the plane adjusting mechanism 1521 by welding after the coupling calibration is completed, and the space between the light distance adjusting mechanism 1522 and the plane adjusting mechanism 1521 is sealed by infusing filler. For z-axis calibration, in the plane adjusting mechanism 1521, a groove track 15213 is disposed at another side of the mechanism body 15211 opposite to the second connection plane 15212. The light distance adjusting mechanism 1522 comprises a body 15221, and an inserted part 15222 disposed at one side of the body 15221 and movable along the groove track 15213. After z-axis calibration is completed, the light distance adjusting mechanism 1522 is fixed on the plane adjusting mechanism 1521 by laser welding or other welding way.

In order to illustrate the z-axis calibration in this embodiment easily, a distance from the transmitting module 12 to the coupling lens 151 is defined as L1, and a distance from the coupling lens 151 to the isolator 1523 is defined as L2. In this embodiment, the coupling lens 151 is disposed on the disposal slot 114 of the base 11, the distance L1 from the transmitting module 12 to the coupling lens 151 is a fixed value, and the distance L2 from the coupling lens 151 to the isolator 1523 is adjusted according to the inserted part 15222 of the light distance adjusting mechanism 1522 and the groove track 15213 of the plane adjusting mechanism 1521. As L1 is fixed, for better coupling efficiency, length of L2 tends towards a fixed value due to convergence characteristic of the coupling lens 151. Therefore, the length of L2 depends on the length of L1. For biconvex lens, such configuration may increase the tolerance between the light distance adjusting mechanism 1522 and the plane adjusting mechanism 1521 since L2>L1, so that difficulty in process can be reduced.

Please refer to FIG. 5 and FIG. 8, the isolator 1523 is disposed between the optical fiber connection mechanism 1524 and the light distance adjusting mechanism 1522. The isolator 1523 can be also disposed to connect one side of the external optical fiber, but it is not limited thereto. The light distance adjusting mechanism 1522 comprises a first disposal slot disposed at one side of the body 15221 to mount the isolator 1523 and a first disposal slot 15223 disposed on the body 15221 and at one side of the first disposal slot 15223. The first disposal slot 15223 is used to mount the isolator 1523. The inner diameter of the second disposal slot 15224 is larger than that of the first disposal slot 15223, so as to form an outer ring region for assembling the optical fiber connection mechanism 1524. The optical fiber connection mechanism 1524 comprises a sleeve body 15241, a light coupling channel 15242 disposed inside the sleeve body 15241, and a positioning portion 15243 disposed at one side of the sleeve body 15241 for fixing the second disposal slot 15224. One end of the light coupling channel 15242 is connected to the external optical fiber correspondingly.

### Second Embodiment

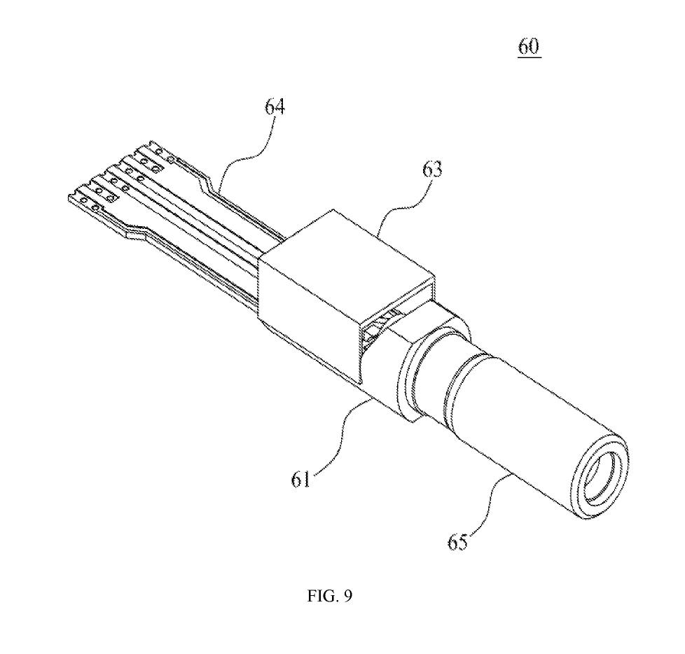

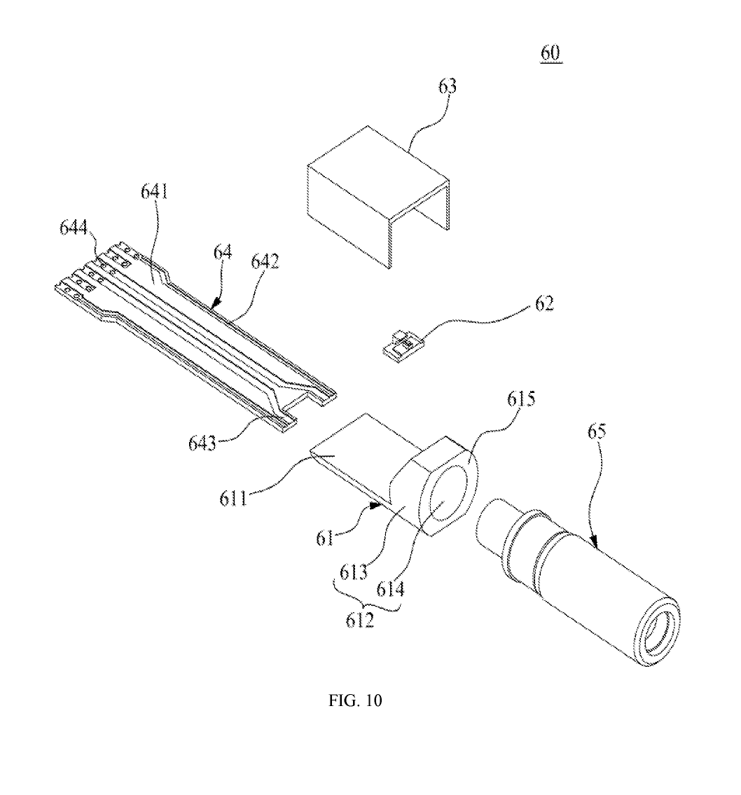

Please refer to FIG. 9 to FIG. 14 for detail structure of a second embodiment according to the present disclosure. Please refer to FIG. 9 and FIG. 10, a package structure for a transmitting device 60 is provided in this embodiment. The package structure for transmitting device 60 mainly comprises a base 61, a transmitting module 62 disposed on the base 61, a cover 63 covering above the transmitting module 62, a circuit board 64 disposed at one side of the base 61 and a cylindrical element 65 mounted at one side of the base 61. The base 61 is made of metal material and can assist the transmitting module 62 to dissipate heat.

The base 61 comprises a plane part 611, and an assembling part 612 disposed on one side the plane part 611. The plane part 611 is used to place the transmitting module 62. The assembling part 612 comprises an annular positioning portion 613 disposed at one side of the plane part 611, an assembly slot 614 disposed inside the annular positioning portion 613 and corresponding to the transmitting module 62. The assembly slot 614 is disposed correspondingly to the cylindrical element 65. The structure of the cylindrical element 65 will be described in detail in following content. The plane part 611 of the base 61 is covered by the cover 63. During manufacturing process, filler is sealed into the space between the cover 63 and the base 61 by infusing the filler or welding, so as to achieve the objective of sealing the transmitting module 62.

One end of the circuit board 64 is integrated with the base 61. The circuit board 64 comprises a board body 642 having a printing circuit 641, an electrical connection side 643 disposed on one end of the board body 642, and an electrical connection port 644 disposed on another end of the board body 642 opposite to the electrical connection side 643. The electrical connection side 643 of the board body 642 is fixed on the plane part 611 of the base 61 by gluing. The transmitting module 62 is connected electrically to the electrical connection side 643 of the board body 642 by welding or wire bonding. The electrical connection port 644 is connected to the baseboard 50 of the optical transceiver module 100, as shown in FIG. 1, and connected electrically to the printing circuit on the baseboard 50 by electrical welding, spot welding, so as to transmit the excitation signal from the baseboard 50 to the transmitting module 62. The cylindrical element 65 is mounted on the assembling part 612 correspondingly. The cylindrical element 65 comprises a cylindrical body 651 connected to the external optical fiber, and a coupling lens 652 disposed at inner inside of the cylindrical body 651, so as to couple the optical signal emitted from the transmitting module 62 to the external optical fiber via cylindrical body 651.

Please refer to FIG. 11 to FIG. 14 for detail structure of the cylindrical element in the second embodiment according to the present disclosure. The structure of the cylindrical element 65 is described in order from left to right.

In the exploded view of structure in FIG. 10, the cylindrical body 651 can be disassembled into a plane adjusting mechanism 6511 and an optical fiber connection mechanism 6512, in order from left to right.

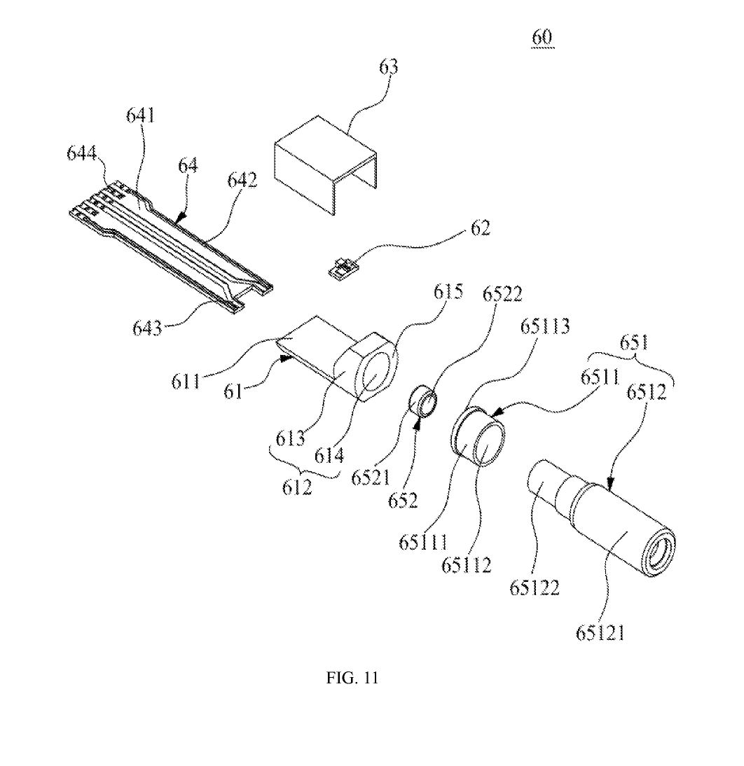

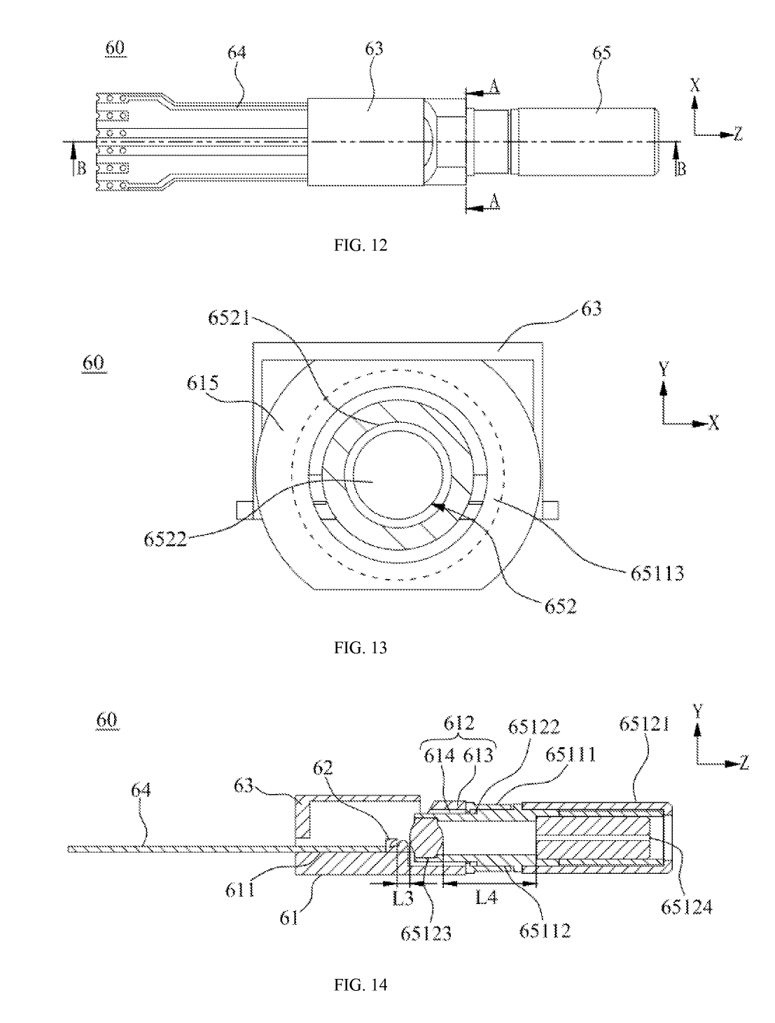

Please refer to both of FIG. 12 and FIG. 13, the plane adjusting mechanism 6511 is integrated on the assembling part 612 by laser spot welding as coupling calibration is completed. For X-Y plane calibration, the assembling part 612 of the base 61 comprises a first connection plane 615 disposed at one side of the annular positioning portion 613. The plane adjusting mechanism 6511 comprises a mechanism body 65111, a through slot 65112 disposed inside the mechanism body 65111 and corresponding to the assembly slot 614, and a second connection plane 65113 disposed at one side of the mechanism body 65111. The second connection plane 65113 corresponds to the first connection plane 615. During calibration, a calibration device is used to adjust the relative position between the cylindrical body 651 and the assembling part 612. After the calibration is done, the first connection plane 615 is fixed on the second connection plane 65113 by laser spot welding, and then X-Y plane calibration is completed.

Please refer to both of FIG. 12 and FIG. 14, the optical fiber connection mechanism 6512 according to the present disclosure is integrated on the plane adjusting mechanism 6511 by welding after the coupling calibration is completed, and the space between the optical fiber connection mechanism 6512 and the plane adjusting mechanism 6511 is sealed by infusing filler. The optical fiber connection mechanism 6512 comprises a sleeve body 65121, a light coupling channel 65124 dispose at inner side of the sleeve body 65121, a light distance adjusting part 65122 disposed at one side of the sleeve body 65121, and a coupling lens 652 disposed at inside side of the light distance adjusting part 6511. A positioning groove 65123 is disposed at inner side of the light distance adjusting part 65122. The coupling lens 652 comprises a metal outer ring part 6521 fixed on the positioning groove 65123, and at least one convex lens or spherical lens, such as biconvex lens 1512 applied in this embodiment, disposed inside the metal outer ring part 6521.

In order to illustrate the z-axis calibration in this embodiment easily, a distance from the transmitting module 62 to the coupling lens 6522 is defined as L3, and a distance from the coupling lens 6522 to the light coupling channel 15242 is defined as L4. In this embodiment, the coupling lens 6522 is disposed on the disposal slot 65123 of the optical fiber connection mechanism 6512, therefore, the distance L4 from the coupling lens 6522 to the light coupling channel 65124 is a fixed value, and the distance L3 from the transmitting module 62 to the coupling lens 652 is adjusted according to the light distance adjusting part 65122 of the optical fiber connection mechanism 6512 and the through slot 65112 of the plane adjusting mechanism 6511. As L4 is fixed, for better coupling efficiency, length of L3 tends towards a fixed value due to convergence characteristic of the coupling lens 652. Therefore, the length of L3 depends on the setting for length of L4.

To sum up, the transmitting device of the present disclosure can be detached independently, so that assembly engineer can replace single transmitting device in failure state.

Besides, the baseboard and cylindrical element of transmitting device of the present disclosure can be detached and detected individually, so that the cylindrical element provided with the coupling lens can be recycled for reuse when the transmitting module is damaged outside.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A transmitting device package structure, comprising:
a base, comprising a plane part mounted with a transmitting module, and an assembling part disposed on one side of the plane part;
a circuit board, comprising a board body, an electrical connection side disposed on one end of the board body and connected with the transmitting module, and an electrical connection port disposed an end of the board body opposite to the electrical connection side; and
a cylindrical element, installed on the assembling part, the cylindrical element comprising a cylindrical body connected to an external optical fiber, and a coupling lens disposed inside the cylindrical body or between the cylindrical body and the transmitting module, the coupling lens coupling the optical signal emitted from the transmitting module to the external optical fiber.

2. The transmitting device package structure according to claim 1, wherein the coupling lens is disposed between the cylindrical body and the transmitting module, and the cylindrical body comprises a plane adjusting mechanism integrated with the assembling part, a light distance adjusting mechanism integrated with the plane adjusting mechanism, and an optical fiber connection mechanism integrated with the light distance adjusting mechanism.

3. The transmitting device package structure according to claim 2, wherein the assembling part comprises an annular positioning portion disposed at one side of the plane part, a positioning groove disposed inside the annular positioning portion to dispose the coupling lens, a first connection plane disposed at one side of the annular positioning portion, and the plane adjusting mechanism comprises a mechanism body, and a second connection plane disposed at one side of the mechanism body and fixed to the first connection plane after a coupling calibration.

4. The transmitting device package structure according to claim 2, wherein the plane adjusting mechanism comprises a mechanism body, a groove track disposed at one side of the mechanism body, and the light distance adjusting mechanism comprises a body, an inserted part disposed at one side of the body and slidable along the groove track and fixed to an inserted part on the groove track after a coupling calibration.

5. The transmitting device package structure according to claim 2, wherein the coupling lens comprises a metal outer ring part fixed on the positioning groove, and at least one convex lens or spherical lens disposed inside the metal outer ring part.

6. The transmitting device package structure according to claim 2, wherein the cylindrical body comprises an isolator between the optical fiber connection mechanism and the light distance adjusting mechanism.

7. The transmitting device package structure according to claim 6, wherein the light distance adjusting mechanism comprises a body, a first disposal slot disposed at one side of the body to mount the isolator, and a second disposal slot disposed on the body and at one side of the first disposal slot, and the optical fiber connection mechanism comprises a sleeve body, a light coupling channel disposed inside the sleeve body to connect with an external optical fiber, and a positioning portion disposed on the sleeve body and at a side of the light coupling channel opposite to the external optical fiber for fixing the second disposal slot.

8. The transmitting device package structure according to claim 1, wherein the cylindrical body comprises a plane adjusting mechanism integrated with the assembling part and an optical fiber connection mechanism integrated with the plane adjusting mechanism, and the coupling lens is disposed inside the optical fiber connection mechanism.

9. The transmitting device package structure according to claim 8, wherein the assembling part comprises an annular positioning portion disposed at one side of the plane part, an assembly slot disposed inside the annular positioning portion, and a first connection plane disposed at one side of the annular positioning portion, and the plane adjusting mechanism comprises a mechanism body, a through slot disposed inside the mechanism body and corresponding to the assembly slot, and a second connection plane disposed at one side of the mechanism body and fixed to the first connection plane after a coupling calibration.

10. The transmitting device package structure according to claim 9, wherein the optical fiber connection mechanism comprise a sleeve body, a light distance adjusting part disposed at one side of the sleeve body and passing through the through slot and the assembly slot, and a coupling lens disposed inside the light distance adjusting part.

11. The transmitting device package structure according to claim 10, wherein the optical fiber connection mechanism comprises a light coupling channel disposed inside the sleeve body and coupling an optical signal which passes the coupling lens, to the external optical fiber.

12. The transmitting device package structure according to claim 10, wherein the optical fiber connection mechanism comprises a positioning groove disposed inside the light distance adjusting part, and the coupling lens comprises a metal outer ring part fixed on the positioning groove and at least one convex lens or spherical lens disposed inside the metal outer ring part.
